(19) United States
(12) Patent Application Publication
(10) Pub. No.: US 2007/0051828 A1
(43) Pub. Date: Mar. 8, 2007

(54) Injection nozzle

(76) Inventor: Michael P. Cooke, Gillingham (GB)

Correspondence Address: DELPHI TECHNOLOGIES, INC., M/C 480-410-202, PO BOX 5052, TROY, MI, 48007, US

(21) Appl. No.: 11/504,917

(22) Filed: Aug. 16, 2006

(30) Foreign Application Priority Data
Aug. 24, 2005 (EP) 05255206.4

(51) Int. Cl. B05B 1/08

(52) U.S. Cl. 239/102.2; 239/533.12; 239/584

(57) ABSTRACT

An injection nozzle for an internal combustion engine includes a nozzle body provided with a bore within which a valve needle is movable along a primary valve needle axis (A-A), the valve needle being engageable with a valve seating defined by the bore to control fuel delivery through an injection nozzle outlet. The nozzle includes a first valve region, a second valve region and a seating region located between the first and second valve regions which seats against the valve seating when the nozzle is in a non-injecting state. A diffusion volume is defined between the valve needle and the bore downstream of the valve seating and into which fuel flows once it has flowed past the valve seating when the valve needle is lifted from the valve seating into an injecting state. The valve needle is provided with a diffusion region of part-spheroidal or part-spherical form to define a smooth transition for a diverging fuel flow into the diffusion volume, thereby to minimise turbulence within the diffusion volume.

### TECHNICAL FIELD

The present invention relates to an injection nozzle for use in a fuel injection system for an internal combustion engine. It relates particularly, but not exclusively, to an injection nozzle for use in a common rail fuel injection system for an internal combustion engine, and one in which a valve needle of the injection nozzle is controlled by means of a piezoelectric actuator.

### BACKGROUND TO THE INVENTION

In common rail fuel injection systems, a plurality of injectors are provided to inject fuel at high pressure into the engine cylinders. Each injector includes an injection nozzle having a valve needle which is operated by means of an actuator to move towards and away from a valve seating so as to control fuel delivery by the injector. It is known that the optimum exhaust emissions are achieved if the rise and fall of the injection rate, at the beginning and end of injection respectively, is as fast as possible, which requires fast movement of the injection nozzle valve needle. Indirect acting injectors typically do not provide a fast needle response as they rely on a servo valve to control operation of the valve needle. Direct-acting piezoelectric injectors, however, are known to provide a fast needle response. In a direct-acting piezoelectric injector the actuator acts directly on the valve needle through a hydraulic and/or mechanical motion amplifier. Our European patent EP 0995901 describes a direct-acting piezoelectric injector of the aforementioned type.

It is one disadvantage of direct-acting injectors that they are electrically relatively inefficient due to the large amount of electrical energy that is required to produce high needle lifts. As well as the issue of direct loss of energy, the life of the piezoelectric actuator is also compromised due to the large amounts of energy required to drive it.

It is an object of the present invention to provide an injection nozzle which addresses the aforementioned problem so as to enable energy efficiency to be improved when implemented, for example, in a direct-acting piezoelectric injector.

### SUMMARY OF INVENTION

According to a first aspect of the invention, there is provided an injection nozzle for an internal combustion engine including a nozzle body provided with a bore within which a valve needle is movable along a primary valve needle axis, the valve needle being engageable with a valve seating defined by the bore to control fuel delivery through an injection nozzle outlet. The valve needle includes a first valve region, a second valve region and a seating region defined between the first and second valve regions which seats against the valve seating when the nozzle is in a non-injecting state. A diffusion volume is defined between the valve needle and the bore downstream of the valve seating, into which fuel flows once it has flowed past the valve seating when the valve needle is lifted from the valve seating into an injecting state. The nozzle is characterised in that the valve needle is provided with a diffusion region of part-spheroidal or part-spherical form to define a smooth transition for fuel as it enters the diffusion volume when the nozzle is in the injecting state, thereby to minimise turbulence within the diffusion volume.

The provision of the smooth transition for fuel as it is diffused or dispersed into the diffusion volume ensures that fuel experiences a smooth gradual change in direction and flow area as it exits the relatively narrow flow channel defined at the valve seating (and optionally for a short way beyond this) and flows beyond this into the region where the available fuel volume starts to increase. The diffusion of fuel (i.e. the diverging flow area) in the diffusion volume is capable of converting, with high efficiency, the relatively high velocity of fuel as it flows past the valve seating into a relatively high fuel pressure in the diffusion volume, before the fuel flow reaches the nozzle outlet. Thus, pressure losses in the diffusion volume are minimised so that flow efficiency in the nozzle is improved. This is particularly beneficial when the nozzle is implemented within a direct-acting piezoelectric injector, as it is possible to utilise lower needle lifts (and hence lower drive energy) to achieve high flow levels even for relatively low needle lifts.

In a conventional injector, the nozzle seat geometries consist of sharp transition edges between regions of conical and/or cylindrical form so that the valve needle seats against the valve seating over a sharp annular seating edge or line. Typically, this results in high turbulence in the diffusion volume and the nozzle sac volume as the fuel flows past the uncovered valve seating, resulting in pressure loss in the diffusion volume which compromises flow efficiency. The present invention overcomes the disadvantages associated with conventional injectors through the use of a smooth transition for fuel flowing into the diffusion volume.

In one embodiment, the seating region of the valve needle is the region of part-spheroidal or part-spherical form so that the seating region itself provides the smooth transition for fuel flowing into the diffusion volume.

Alternatively, the diffusion region of the valve needle which is of part-spheroidal or part-spherical form is additional to the seating region so that the seating region may be defined by a transition edge between the first and second valve regions. Despite the sharp transition edge of the seating, the advantageous flow efficiency benefits of the invention are achieved by virtue of the additional part-spherical or part-spheroidal region defining the path for fuel as it diffuses into the diffusion volume.

In another alternative, the valve needle may include one region of part-spheroid or part-spheroidal form to define the seating region, with a further part-spheroid or part-spheroidal region being provided to define the diffusion region further downstream the needle axis. A frusto-conical region is sandwiched between the seating region and the diffusion region to define a close clearance for fuel once it has past the uncovered valve seating and before it enters the diffusion volume proper.

According to a second aspect of the invention, there is provided an injection nozzle for an internal combustion engine including a nozzle body provided with a bore within which the valve needle is movable along a primary valve needle axis, the valve needle being engageable with a valve seating defined by the bore to control fuel delivery through an injection nozzle outlet. The valve needle includes a first valve region, a second valve region and a seating region defined between the first and second valve regions which seats against the valve seating when the nozzle is in a non-injecting state. A diffusion volume is defined between the valve needle and the bore downstream of the valve seating, into which fuel flows once it has flowed past the valve seating when the valve needle is lifted from the valve seating into an injecting state. The nozzle is characterised in that the valve needle is provided with a radiussed or curved surface which defines a smooth transition for diverging fuel flow as it enters the diffusion volume when the nozzle is in the injecting state, thereby to minimise turbulence within the diffusion volume.

According to a third aspect of the invention, there is provided a direct-acting piezoelectric fuel injector having a piezoelectric actuator and an injection nozzle of the first or second aspect, wherein the actuator is configured to control movement of the valve needle of the nozzle towards and away from the valve seating.

### BRIEF DESCRIPTION OF DRAWINGS

The invention will be described, by way example only, with reference to the accompanying drawings, in which:

FIG. 1 is a sectional view of a part of an injection nozzle in accordance with a first embodiment of the invention when in a non-injecting state,

FIG. 2 is a sectional view of the injection nozzle in FIG. 1 when in an injecting state,

FIGS. 3, 4 and 5 are sectional views of second, third and fourth embodiments of the injection nozzle, respectively, when in injecting states,

FIG. 6 is a sectional view of a fifth embodiment of the injection nozzle when in a non-injecting state,

FIG. 7 is a sectional view of the injection nozzle in FIG. 6 when in an injecting state,

FIG. 8 is a sectional view of a sixth embodiment of the injection nozzle when in a non-injecting state,

FIG. 9 is a sectional view of the injection nozzle in FIG. 8 when in an injecting state,

FIG. 10 is a sectional view of a seventh embodiment of the injection nozzle when in a non-injecting state,

FIG. 11 is a sectional view of the injection nozzle in FIG. 10 when in an injecting state,

FIG. 12 is a sectional view of an eighth embodiment the injection nozzle when in a non-injecting state, and

FIG. 13 is a sectional view of the injection nozzle in FIG. 12 when in an injecting state.

### DETAILED DESCRIPTION OF PREFERRED EMBODIMENTS

The injection nozzle of the present invention is of the type suitable for implementation within an injector having a piezoelectric actuator for controlling movement of an injection nozzle valve needle. The injector is typically of the type used in common rail fuel injection systems for internal combustion engines (for example compression ignition—diesel—engines). It is a particular advantage of the invention that the nozzle can be used in direct-acting piezoelectric injectors, where the piezoelectric actuator controls movement of the valve needle through a direct action, either via a hydraulic or mechanical amplifier or coupler, or by means of a direct connection.

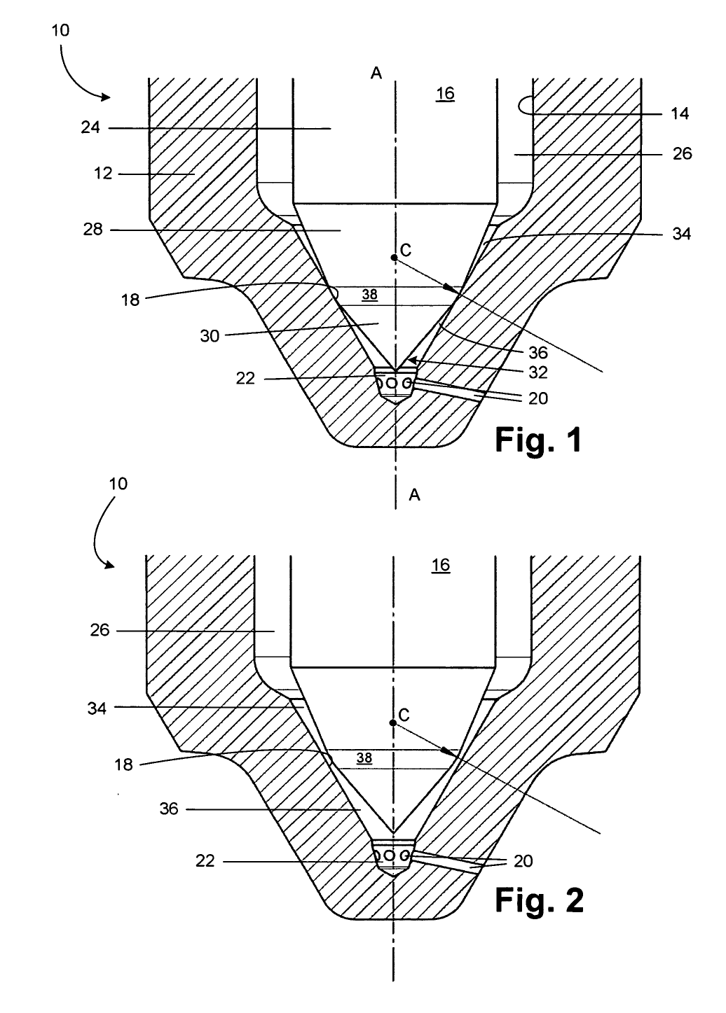

FIG. 1 shows an injection nozzle 10 in accordance with a first embodiment of the invention, the nozzle including a nozzle body 12 provided with a blind bore 14 within which a valve needle 16 is movable to engage with, and disengage from, a valve needle seating 18 defined by the blind end of the bore 14. The valve seating 18 is of substantially frusto-conical form, as is known in the art, and the nozzle body 12 is provided with a plurality of injection nozzle outlets 20 through which fuel is injected to the associated engine cylinder or combustion space in circumstances in which the valve needle 16 is lifted from its seating 18. The blind end of the bore 14 defines a sac volume 22 with which inlet ends of the nozzle outlets 20 communicate.

The valve needle 16 includes an upper region 24 of cylindrical form which defines, together with the internal bore surface upstream of the valve seating 18, a delivery chamber 26 for receiving high pressure fuel from an inlet (not shown) to the injector of which the nozzle forms a part. Adjacent to the upper region 24, and located further downstream, the needle includes a first region 28 of substantially frusto-conical form (referred to as the entry region 28 of the nozzle) and, further downstream still, a second region 30 of substantially frusto-conical form (referred to as the exit region of the nozzle) which terminates in a valve tip 32. The entry region 28 of the valve needle 16 defines, together with the bore 14, an entry volume 34 for fuel in communication with the delivery chamber 26. The exit region 30 of the valve needle 16 defines, together with the adjacent region of the bore 14, a further volume 36 into which the fuel flow diverges or diffuses immediately it has passed through the narrow restriction at the valve seating 18 when the valve needle 16 is lifted, as shown in FIG. 2. For the purpose of this specification, this further volume will be referred to as the ‘diffusion volume’ 36 by virtue of the fact that fuel entering the volume is diffused into the volume once it has traversed the relatively restricted gap between the valve needle 16 and the seating 18, as described further below.

Between the entry and exit regions 28, 30 of the valve needle 16, the needle includes a further separate and distinct seating region 38 which is of part-spherical form, with the outer surface of the spherical region 38 being that surface of the valve needle 16 that engages with the valve seating 18. The seating region 38 thus defines a radiussed or curved area of the needle over which the needle 16 seats when the nozzle is in the non-injecting state of FIG. 1. The sphericity of the seating region 38 is selected so that the centre, C, of the sphere lies on the primary axis A-A along which the valve needle 16 is movable. The part-spherical seating region 38 tapers into the conical exit region 30 of the valve needle 16 to define a smooth transition between these parts. In other words, the part-spherical seating region is considered to be a diffusion region of the needle. With the entry 28, exit 30 and seating regions 38 of the valve needle 16 having the shape and configuration described above, the valve needle 16 therefore has a ‘cone-sphere-cone’ geometry.

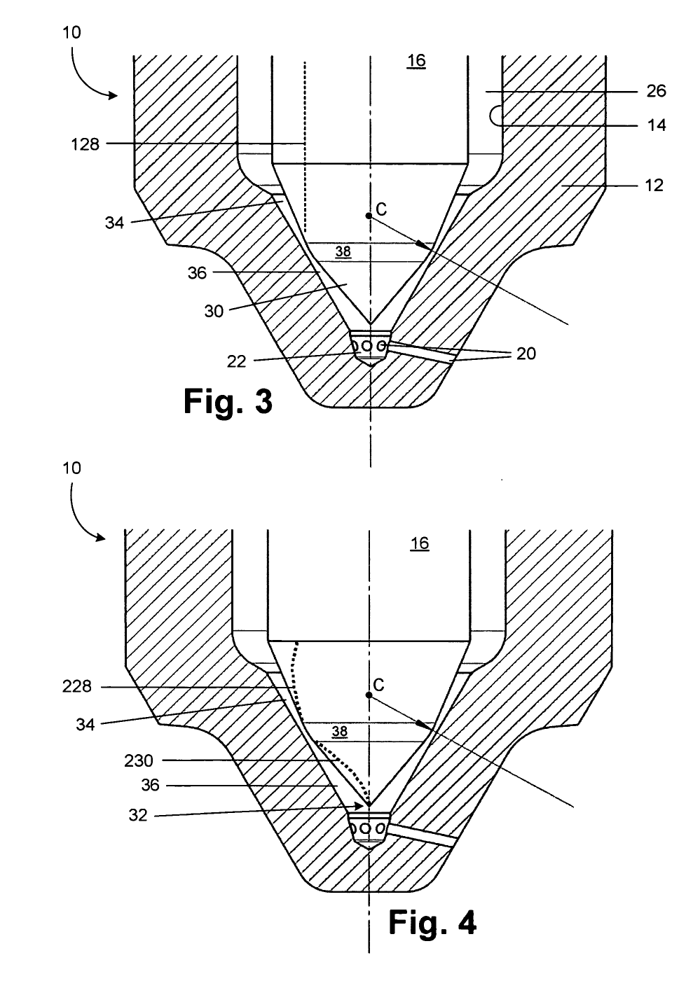

Referring to FIG. 2, when the valve needle 16 is actuated to lift from the valve seating 18 by means of the piezoelectric actuator, fuel delivered to the delivery chamber 26 and the entry volume 34 is able to flow past the uncovered valve seating 18, into the diffusion volume 36 and, hence, into the nozzle outlets 20 via the sac volume 22. Because of the spherical nature of the seating region 38, there is no sharp transition for the fuel flow as it flows past the uncovered valve seating 18 into the region beyond this where the available fuel volume starts to increase (i.e. the diffusion volume 36). Thus, pressure losses in the diffusion volume 36 are minimised as the flow past the seating 18 experiences only a smooth and gradual change in flow area and direction. Fuel flowing past the valve seating 18 into the diffusion volume 36 is therefore able to recover, in an efficient manner, a relatively high pressure level prior to reaching the nozzle outlets 20. The nozzle 10 therefore provides an efficient flow geometry which has been found to enable high flow levels for relatively low values of needle lift. As a consequence, the energy demand on the injector is reduced so that the nozzle provides a particular advantage when implemented within a direct-acting injector of the type described previously. Referring to FIG. 3, there is shown a second embodiment of the injection nozzle 10 when in an unseated position in which the configuration of the entry region of the needle 16 is altered, as indicated by the dotted line. The nozzle in FIG. 3 is similar to that shown in FIGS. 1 and 2 in that it includes a seating region 38 of part-spherical form to define a radiussed seating area of the needle 16, with the centre, C, of the sphere being defined along the primary needle axis A-A. However, in FIG. 3 the entry region 128 is of cylindrical form, rather than being conical. The cylindrical region 128 defines, together with the bore 14, the entry volume 34 in communication with the delivery chamber 26. The exit region 30 of the valve needle 16 takes the same form to that shown in FIGS. 1 and 2 and other like parts are identified with like reference numerals. The FIG. 3 embodiment provides similar flow efficiency advantages to those described previously by virtue of the smooth transition for fuel flowing past the part-spherical seating region 38 into the diffusion volume 36. With the entry 128, exit 30 and seating regions 38 of the valve needle formed as described above, the valve needle 16 has a ‘cylinder-sphere-cone’ geometry.

Referring to FIG. 4, in a third embodiment the nozzle is further modified in that the upper region 228 of the valve needle 16 is of part-spherical form (as indicated by dotted lines) and the exit region 230 of the valve needle 16 (as indicated by dotted lines) is of concave form, terminating in the valve tip 32. The part-spherical upper region 228 has the centre of its sphere at a different point to the centre, C, of the sphere defining the part-spherical seating region 38. Again, this embodiment provides a smooth transition for fuel flowing into the diffusion volume 36 once it has traversed the narrow channel at the valve seating 18 and so also realises the aforementioned flow efficiency advantages. With the entry 228, exit 230 and seating regions 38 of the valve needle 16 formed as described above, the valve needle 16 has a ‘sphere-sphere-concave’ geometry.

As an alternative to the configuration described in FIG. 4, the part-spherical upper region 228 of the valve needle 16 may be configured such that it is defined by the same sphere as that defining the seating region 38.

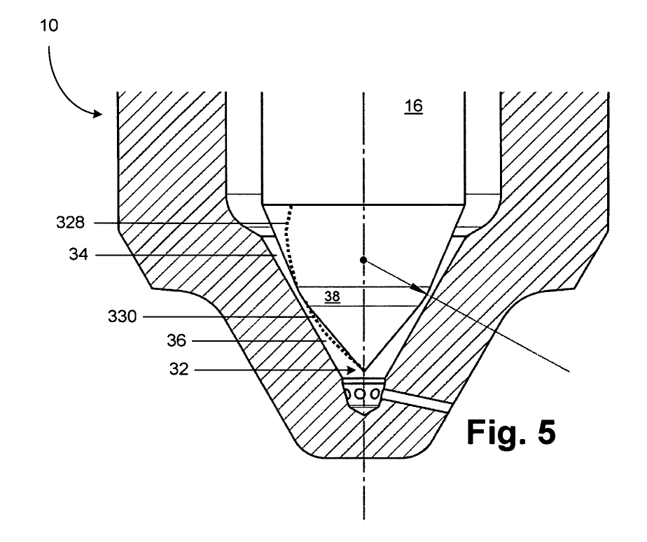

Referring to FIG. 5, in a fourth embodiment of the invention the upper region 328 of the valve needle 16 (as indicated by dotted lines) takes the same part-spherical form to that shown in FIG. 4, but instead of being concave the exit region 330 of the valve needle 16 is of convex form (as indicated by dotted lines), with the convex region 330 terminating in the valve tip 32. Again, this embodiment ensures there of a smooth transition for fuel flowing into the diffusion volume 36 and so also realises the aforementioned flow efficiency advantages. With the entry 328, exit 330 and seating regions 38 of the valve needle 16 formed as described above, the valve needle 16 has a ‘sphere-sphere-convex’ geometry.

The embodiments of FIGS. 3, 4 and 5 represent specific combinations of various geometries of the entry and exit regions of the valve needle 16, together with a part-spherical seating region 38. In practice, various other combinations of the entry and exit regions are possible (for example, cylinder-sphere-convex or sphere-sphere-cone), whilst maintaining the benefits of the smooth transition for fuel flowing into the diffusion volume 36 by virtue of the part-spherical seating region 38.

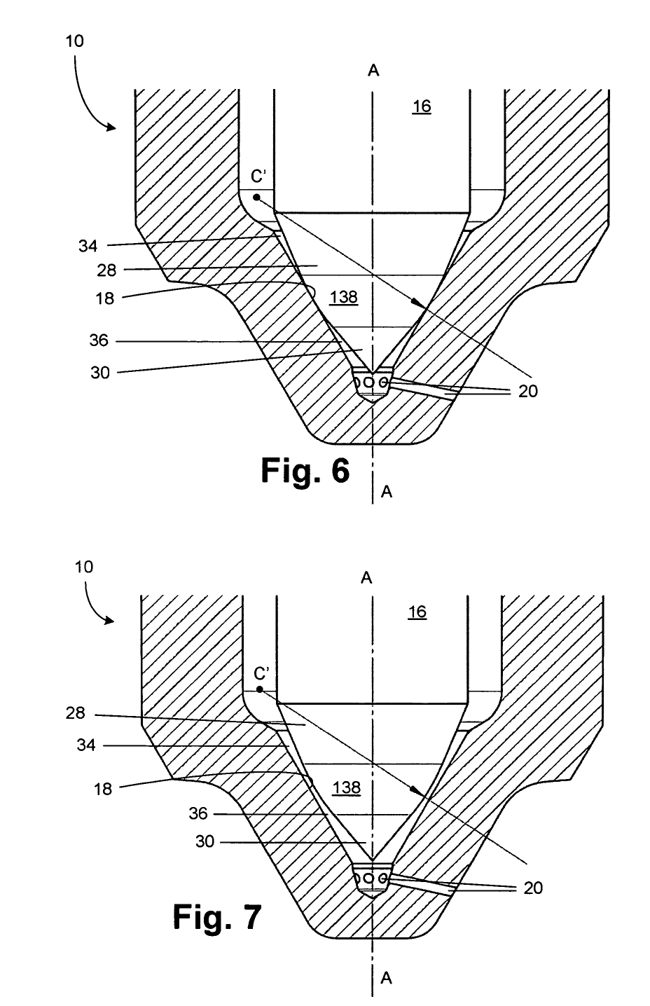

Referring to FIGS. 6 and 7, in a fifth embodiment of the invention the part-spherical seating region of the valve needle in FIGS. 1 and 2 is replaced with a part-spheroidal region 138 to define the radiussed or curved area of the needle 16 over which it seats against the valve seating 18. The part-spheroidal region 138 of the valve needle 16 differs from a part-spherical region 38 described previously in that the centre, C′, of the sphere defining the seating region 138 does not lie on the primary axis A-A of the needle 16 but instead lies at a point displaced laterally from it. Due to the provision of the part-spheroidal region 138, the valve needle 16 adopts a “rugby ball” shape. In FIGS. 6 and 7, the entry region 28 of the valve needle 16 defining the entry volume 34 is of substantially frusto-conical form (as in FIGS. 1 and 2) and the exit region 30 of the valve needle is of substantially frusto-conical form (as in FIGS. 1 and 2) so that the valve needle 16 has a ‘cone-spheroid-cone’ geometry. The use of the part-spheroidal seating region 138 provides the same advantageous benefits of the part-spherical region 38 described previously as it serves to generate a smooth, efficient path for fuel flowing from the entry volume 34, past the valve seating 18 and into the diffusion volume 36. As a result, turbulence within the diffusion volume 36 is minimised and, hence, high pressure is restored within the diffusion volume 36 in an efficient manner, prior to injection through the outlets 20. The embodiment of FIGS. 6 and 7 provides the further advantage that the rate of change of fuel flow direction at the valve seating 18 is further optimised.

It will be appreciated that alternative configurations for the entry 28 and exit regions 30 in FIGS. 6 and 7 are also possible with a seating region 138 of part-spheroidal form (for example cylinder-spheroid-cone, convex-spheroid-concave and cone-spheroid-convex) whilst maintaining the aforementioned advantages of having a smooth transition for fuel flowing into the diffusion volume 36.

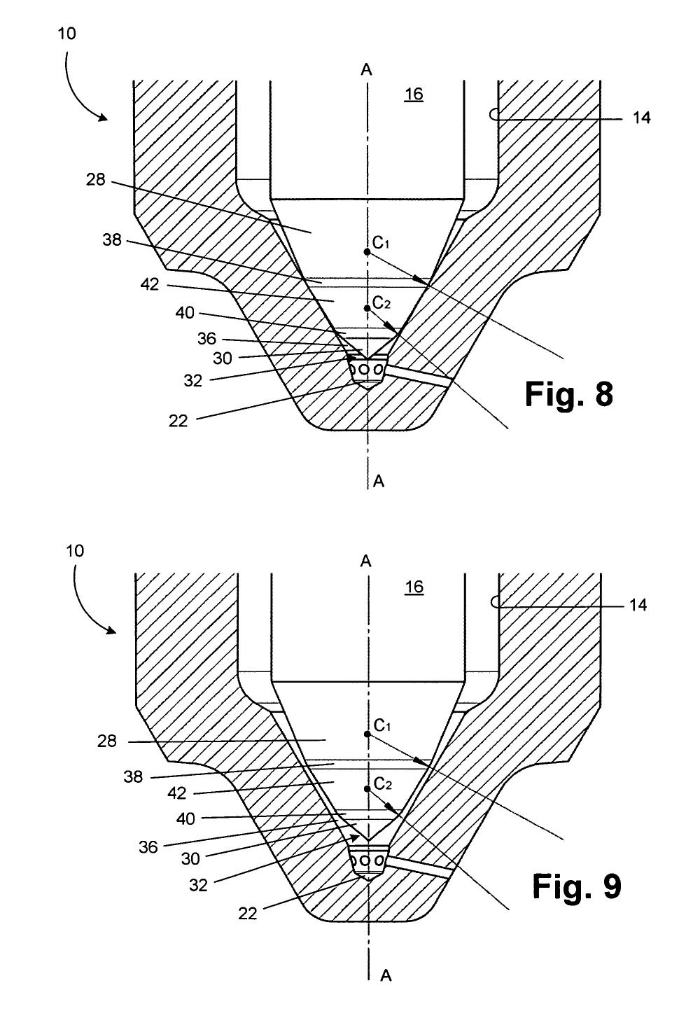

For some applications it is possible that the embodiments described previously may not be ideal if there is a requirement for a large seating area (e.g. for impact resistance) for the needle 16. In such circumstances, the sac 22 inevitably has a relatively large volume which is not ideal for minimal hydrocarbon emissions. Referring to FIGS. 8 and 9, in a sixth embodiment of the invention this issue is addressed by providing the valve needle 16 with an additional part-spherical region 40 and an additional frusto-conical region 42. The additional frusto-conical region 42 is located immediately downstream of the seating region 38 and the additional part-spherical region 40 is located immediately downstream of this. Thus, the valve needle 16 includes the following separate and distinct regions: a frusto-conical entry region 28 (as in FIGS. 1 and 2 for example), a first part-spherical region 38 to define the seating region, an additional frusto-conical region 42 immediately downstream of the seating region 38 of the needle, an additional part-spherical region 40 immediately downstream of this region 42 and an exit region 30 of substantially frusto-conical form (as in FIGS. 1 and 2 for example) which terminates in the valve tip 32. The valve needle therefore has a cone-sphere-cone-sphere-cone geometry, with the centres C₁, C₂ of the part-spherical regions 38, 40, respectively, lying on the primary needle axis A-A.

The additional frusto-conical region 42 defines a close clearance with the adjacent region of the bore 14 so that, when the valve needle 16 is lifted from the valve seating 18, as in FIG. 9, the smooth transition for fuel flowing past the valve seating 18 into the diffusion volume 36 occurs further away from the valve seating 18 than in the previous embodiments (i.e. once fuel has flowed through the narrow clearance channel defined between the additional frusto-conical region 42 and the bore 14) and much closer to the sac volume 22. The volume of the sac 22 is therefore much reduced, providing a benefit for hydrocarbon emissions. It will be appreciated from the embodiment in FIGS. 8 and 9 that the diffusion volume 36 into which fuel is dispersed once it has flowed past the uncovered valve seating 18 is therefore not necessarily defined between that region of the valve needle 16 immediately downstream of the valve seating 18, but may be defined further downstream by shaping the needle 16 to maintain a narrow channel for fuel flow some way beyond the valve seating 18.

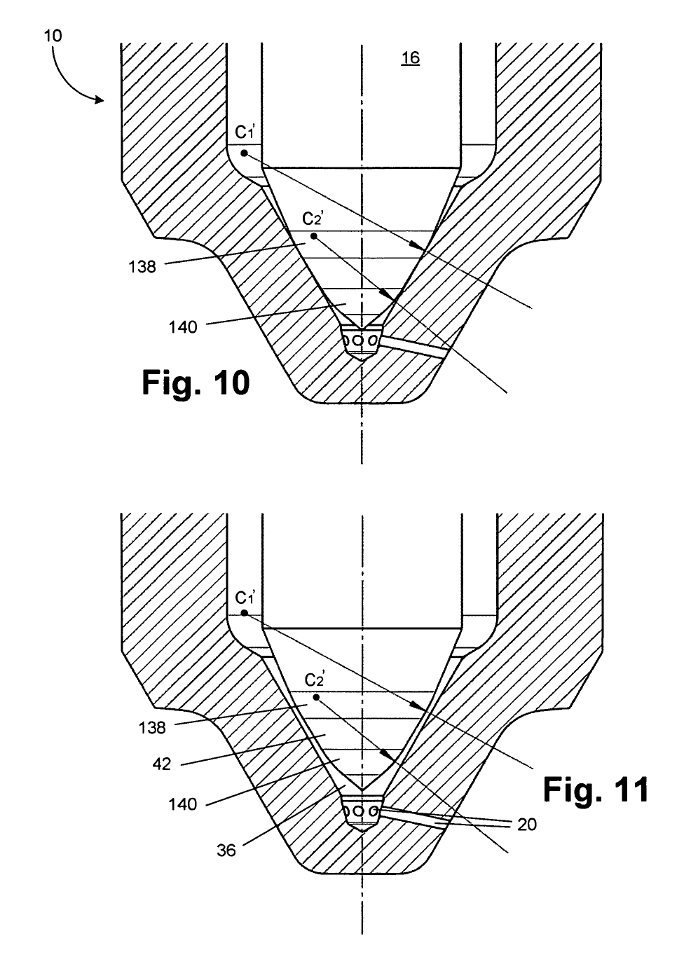

FIGS. 10 and 11 show a seventh embodiment of the injection nozzle 10 in seated and unseated positions, respectively, in which the valve needle 16 has a similar configuration to that in FIGS. 8 and 9 except that the part-spherical regions 38, 40 are replaced with part-spheroidal regions 138, 140, respectively. Similar benefits are achieved to those described previously for FIGS. 6 and 7. The part-spheroidal regions 138, 140 of the valve needle 16 are defined as such by virtue of the centre of each sphere C₁′ and C₂′ being laterally displaced from the primary needle axis A-A. When the valve needle 16 is lifted away from the valve seating 18, as shown in FIG. 11, fuel is able to flow past the uncovered valve seating 18 and through the narrow clearance defined between the additional frusto-conical region 42, before diffusing into the diffusion volume 36 located immediately downstream. As turbulence within the diffusion volume 36 is minimised due to the smooth transition provided by the part-spheroidal region 140, high pressure is re-established within the diffusion volume 36 relatively efficiently, prior to fuel being injected through the nozzle outlets 20.

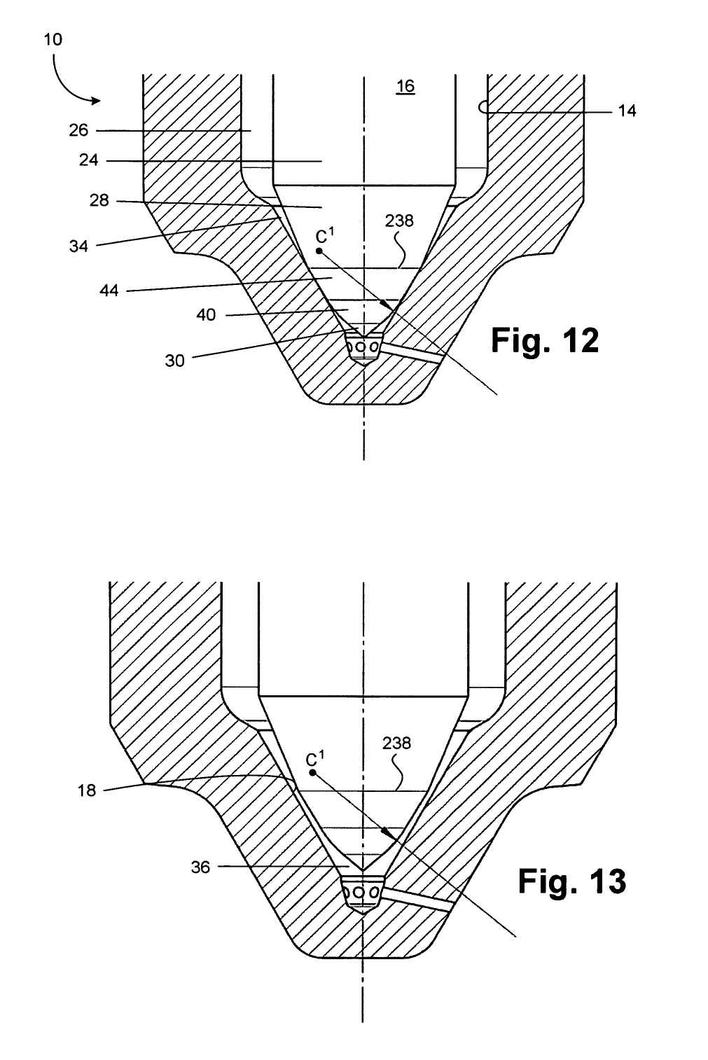

FIGS. 12 and 13 show an eighth embodiment of the invention in seated and unseated positions, respectively. This embodiment differs from those described previously in that the smooth transition for fuel flow into the diffusion volume is not initiated until some way downstream of the valve seating 18. The valve needle 16 includes an upper region 24 of cylindrical form which lies adjacent to an entry region of the needle 16 in the form of a substantially frusto-conical region 28. The entry region 28 defines, together with an adjacent region of the bore 14, an entry volume 34 for fuel received from the delivery chamber 26. Immediately downstream of the entry region 28, the needle 16 includes an additional substantially frusto-conical region 44 so that the seating region of the valve needle is defined by an annular transition edge 238 between the two conical regions 28, 44 (i.e. an annular seating line). This is in contrast to the previous embodiments in which the seating region is part-spherical or part-spheroidal in form.

The seat configuration in FIGS. 12 and 13 is therefore similar to the seating configuration in a conventional injector. However, it is an important feature of the nozzle in FIGS. 12 and 13 that immediately downstream of the frusto-conical region 44 the valve needle 16 is provided with a part-spheroidal region 40 (i.e. similar to the region 44 in FIGS. 8 and 9) and, immediately downstream of this, a region 44 of substantially frusto-conical form. Referring to FIG. 13 specifically, when the valve needle 16 is lifted from the valve seating 18 the exit region 30 defines, together with the adjacent region of the bore 14, a diffusion volume 36 for fuel. By virtue of the part-spheroidal shaping of the region 40, the transition for fuel flowing into the diffusion volume 36 is a smooth one, despite the fact that the needle is provided with a sharp transition edge at the seating line 238. Most of the aforementioned flow efficiency benefit is therefore also achieved with the embodiment of FIGS. 12 and 13.

It will be appreciated that further embodiments of the invention may be realised by providing different combinations of valve regions without compromising the beneficial effect of providing a part-spherical or part-spheroidal region on the valve needle to ensure a smooth transition for fuel as it diffused into the enlarged volume of the nozzle (the diffusion volume 36) once it has flowed past the valve seating 18 and prior to injection through the nozzle outlets.

1. An injection nozzle for an internal combustion engine, the injection nozzle including:
a nozzle body having a bore, a valve seating defined by the bore and an injection nozzle outlet;
a valve needle movable within the bore along a primary valve needle axis (A-A) and being engageable with the valve seating to control fuel delivery through the injection nozzle outlet;
a diffusion volume defined between the valve needle and the bore downstream of the valve seating and into which fuel flows once it has flowed past the valve seating when the valve needle is lifted from the valve seating into an injecting state;
said valve needle including a first valve region, a second valve region, a seating region located between said first and second valve regions which seats against the valve seating when the nozzle is in the non-injecting state, and a diffusion region of part-spheroidal or part-spherical form to define a smooth transition for a diverging fuel flow into the diffusion volume, thereby to minimize turbulence within the diffusion volume; wherein the diffusion region is an additional region separate and distinct from the seating region.

2. The injection nozzle as claimed in claim 1, wherein the seating region is of part-spherical or part-spheroidal form, the second region is of frusto-conical form, and the diffusion region of part-spheroidal or part-spherical form is located immediately downstream of the second region.

3. The injection nozzle as claimed in claim 2, wherein the seating region is of part-spherical form with the centre of its sphere on the primary valve needle axis (A-A).

4. The injection nozzle as claimed in claim 2, wherein the seating region is of part-spheroidal form with the centre of its sphere displaced laterally from the primary valve needle axis (A-A).

5. The injection nozzle as claimed in claim 1, wherein the diffusion region is of part-spherical form with the centre of its sphere on the primary valve needle axis (A-A).

6. The injection nozzle as claimed in claim 1, wherein the diffusion region is of part-spheroidal form with the centre of its sphere displaced laterally from the primary valve needle axis (A-A).

7. The injection nozzle as claimed in claim 1, wherein the seating region is defined by a transition edge between the first and second valve regions.

8. The injection nozzle as claimed in claim 1, wherein the first valve region is cylindrical.

9. The injection nozzle as claimed in claim 1, wherein the first valve region is also of part-spherical or part-spheroidal form.

10. The injection nozzle as claimed in claim 9, wherein the first valve region is of part-spherical form with the centre of its sphere on the primary valve needle axis (A-A).

11. The injection nozzle as claimed in claim 10, wherein the first valve region is of part-spherical form with the centre of its sphere at a different point to the centre of the sphere defining the part-spherical seating region.

12. The injection nozzle as claimed in claim 9, wherein the first valve region is of part-spheroidal form with the centre of its sphere displaced laterally from the primary valve needle axis (A-A)

13. A direct-acting piezoelectric fuel injector having a piezoelectric actuator and an injection nozzle as claimed in claim 1, wherein the actuator is configured to control movement of the valve needle of the nozzle towards and away from the valve seating.

14. An injection nozzle for an internal combustion engine, the injection nozzle including:
a nozzle body having a bore, a valve seating defined by the bore and an injection nozzle outlet;
a valve needle movable within the bore along a primary valve needle axis (A-A) and being engageable with the valve seating to control fuel delivery through the injection nozzle outlet;
a diffusion volume defined between the valve needle and the bore downstream of the valve seating and into which fuel flows once it has flowed past the valve seating when the valve needle is lifted from the valve seating into an injecting state;
said valve needle including a first valve region a second valve region, a seating region located between said first and second valve regions which seats against the valve seating when the nozzle is in the non-injecting state, and a diffusion region of part-spheroidal or part-spherical form to define a smooth transition for a diverging fuel flow into the diffusion volume, thereby to minimize turbulence within the diffusion volume; wherein the seating region is the diffusion region of the valve needle, and wherein the first valve region is also of part-spherical or part-spheroidal form with the centre of its sphere at a different point to the centre of the sphere defining the seating region.

15. The injection nozzle as claimed in claim 14, wherein the seating region is of part-spherical form with the centre of its sphere on the primary valve needle axis (A-A).

16. The injection nozzle as claimed in claim 14, wherein the seating region is of part-spheroidal form with the centre of its sphere displaced laterally from the primary valve needle axis (A-A).

17. The injection nozzle as claimed in claim 14, wherein the second valve region is of frusto-conical form.

18. The injection nozzle as claimed in claim 14, wherein the second valve region is concave and terminates in a valve tip.

19. The injection nozzle as claimed in claim 14, wherein the second valve region is convex and terminates in a valve tip.

20. The injection nozzle as claimed in claim 14, wherein the seating region is defined by a transition edge between the first and second valve regions.

21. The injection nozzle as claimed in claim 14, wherein the first valve region is of part-spherical form with the centre of its sphere on the primary valve needle axis (A-A).

22. The injection nozzle as claimed in claim 14, wherein the first valve region is of part-spheroidal form with the centre of its sphere displaced laterally from the primary valve needle axis (A-A)

23. A direct-acting piezoelectric fuel injector having a piezoelectric actuator and an injection nozzle as claimed in claim 14, wherein the actuator is configured to control movement of the valve needle of the nozzle towards and away from the valve seating.
